(19) United States
(12) Patent Application Publication
(10) Pub. No.: US 2006/0059382 A1
(43) Pub. Date: Mar. 16, 2006

(54) Method of skew adjustment

(76) Inventor: Glenn H. Schneider, Phoenix, AZ (US)

Correspondence Address: MOTOROLA, INC., LAW DEPARTMENT, 1303 E. ALGONQUIN ROAD, SCHAUMBURG, IL, 60196, US

(21) Appl. No.: 10/937,972

(22) Filed: Sep. 10, 2004

(51) Int. Cl. G06F 13/24

(52) U.S. Cl. 713/503

(57) ABSTRACT

In a multi-service platform system (300), a method of skew adjustment can include providing an initiator VME module (302) coupled to a responder VME module (304) over a parallel multi-drop bus network (306). The initiator VME module communicates a calibration cycle (316) to the responder VME module during a calibration phase (208), where the calibration cycle includes a reference signal (322) and a training data signal (324) having a preset relationship (321), and where the calibration cycle is communicated using a source synchronous protocol (107). The responder VME module calculates a deviation (350) from the preset relationship of the reference signal and the training data signal, where the deviation comprises a delay time (325). The initiator VME module communicates a data signal (418) to the responder VME module during a data phase (210), where the data signal includes the reference signal and an actual data signal (426). The responder VME module delays one of the reference signal and the actual data signal by the delay time.

### BACKGROUND OF THE INVENTION

In current high-speed data networks, such as multi-service platform systems using parallel multi-drop bus networks, maximum transfer speeds are limited by, among other things, the skew budget of the buffers located in the various computing modules and the skew time that can occur during transfer time of the signals as they propagate from module to module via a backplane. Due to the myriad of factors affecting signal integrity on the parallel bus, it is difficult to optimize transfer speed between payload nodes for a given configuration.

Accordingly, there is a significant need for an apparatus and method that overcomes the deficiencies of the prior art outlined above.

### BRIEF DESCRIPTION OF THE DRAWINGS

Referring to the drawing:

FIG. 1 depicts a multi-service platform system according to one embodiment of the invention;

FIG. 2 depicts a ladder diagram according to an embodiment of the invention;

FIG. 3 depicts a multi-service platform system according to another embodiment of the invention; and

FIG. 4 depicts a multi-service platform system according to yet another embodiment of the invention; and

FIG. 5 illustrates a flow diagram of a method of the invention according to an embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

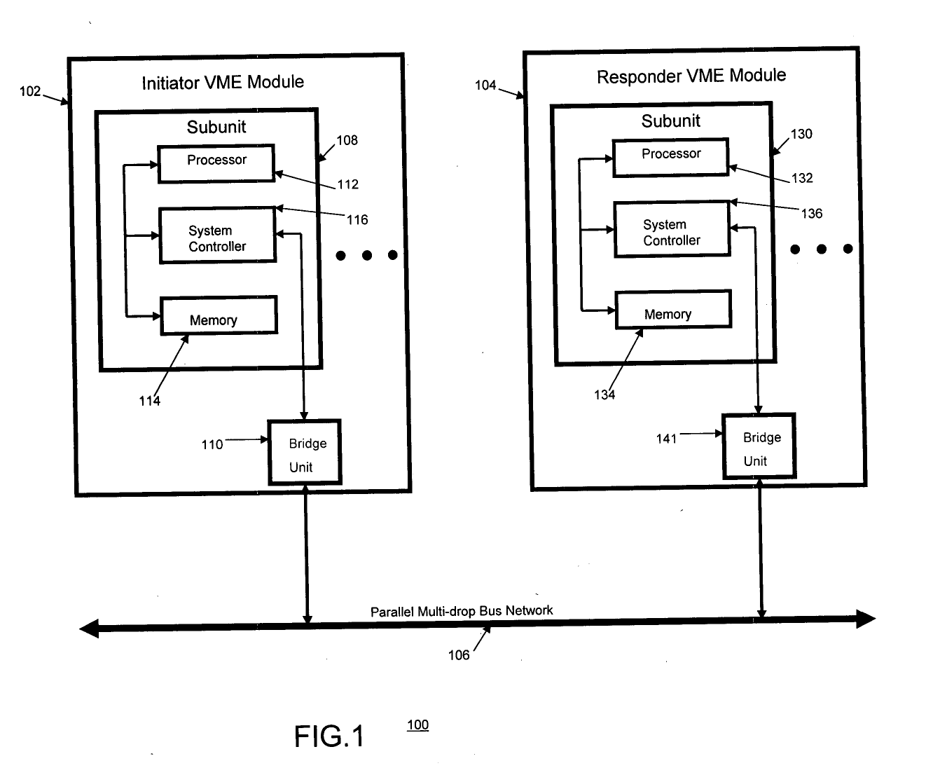

FIG. 1 depicts a multi-service platform system 100 according to one embodiment of the invention. Multi-service platform system 100 can include an embedded-type computer chassis (as opposed to an enterprise based chassis), with software and any number of slots for inserting modules. In a particular embodiment, multi-service platform system 100 can include a VERSAmodule Eurocard (VME) chassis and slots for inserting VME compatible modules. VME modules can add functionality to multi-service platform system 100 through the addition of processors, memory, storage devices, and the like. A backplane can be used for connecting VME modules placed in the slots of multi-service platform system 100.

Multi-service platform system 100 can include any number of VME modules coupled to parallel multi-drop bus network 106. Parallel multi-drop bus network 106 can include hardware and software necessary to implement a data network using VMEbus parallel multi-drop protocols. An example of a parallel multi-drop topology is a VERSAmodule Eurocard (VMEbus) system using any of the VMEbus protocols known in the art. VMEbus is defined in the ANSI/VITA 1-1994 and ANSI/VITA 1.1-1997 standards, promulgated by the VMEbus International Trade Association (VITA), P.O. Box 19658, Fountain Hills, Arizona, 85269 (where ANSI stands for American National Standards Institute). In an embodiment of the invention, VMEbus parallel multi-drop protocols can include, but are not limited to, Single Cycle Transfer protocol (SCT), Block Transfer protocol (BLT), Multiplexed Block Transfer protocol (MBLT), Two Edge VMEbus protocol (2 eVME) and Two Edge Source Synchronous Transfer protocol (2eSST). Details on 2eSST can be found in the VITA 1.5 specification. These VMEbus protocols are known in the art. In a particular embodiment, parallel multi-drop bus network 106 can operate using source synchronous protocol 107. An example of a source synchronous protocol 107 is the 2eSST protocol cited above. Source synchronous protocols are known in the art.

As shown in FIG. 1, multi-service platform system 100 can include initiator VME module 102 and responder VME module 104. In an embodiment, parallel multi-drop bus network 106 couples initiator VME module 102 and responder VME module 104. Other VMEbus modules can be included in multi-service platform system 100 and be within the scope of the invention.

Initiator VME module 102 can include a subunit 108, where subunit includes processor 112 and memory 114. Memory 114 can comprise control algorithms, and can include, but is not limited to, random access memory (RAM), read only memory (ROM), flash memory, electrically erasable programmable ROM (EEPROM), and the like. Memory 114 can contain stored instructions, tables, data, and the like, to be utilized by processor 112. In an embodiment, subunit 108 can also include system controller 116 for controlling one or more subunits, processors, and the like, on initiator VME module 102. System controller 116 can be a part of subunit 108 or be independent of subunit 108 and control other subunits as well. In another embodiment, initiator VME module 102 can include more than one subunit, where other subunits can have any combination of processors, memory, and the like. In another embodiment, subunit 108 can include other elements such as data storage units (disk drives), and the like.

In an embodiment, initiator VME module 102 can also include bridge unit 110, which can be hardware and/or software to provide an interface between subunit 108 on initiator VME module 102 and parallel multi-drop bus network 106. Each subunit 108 is coupled to communicate with bridge unit 110. In addition, bridge unit 110 is coupled to communicate with parallel multi-drop bus network 106.

In an embodiment, subunits can be coupled to bridge unit 110 and can communicate with bridge unit 110 through a parallel multi-drop network, which can use for example, a Peripheral Component Interconnect-X (PCI-X) based protocol. In an embodiment of the invention, PCI-X based protocols can include both PCI and PCI-X2 protocols. Bridge unit 110 is capable of communicating with subunit 108 using any variant of the PCI-X based protocol. Examples of variants of PCI-X protocols, without limitation, include 133 MHz 64-bit PCI-X, 100 MHz 64-bit PCI-X down to 66 MHz 32-bit PCI-X, and the like. Bridge unit 110 can also communicate with subunit 108 using any variant of older PCI based protocols (a subset of PCI-X based protocols), for example and without limitation, 66 MHz 64-bit PCI down to 33 MHz 32-bit PCI, and the like.

Bridge unit 110 can allow initiator VME module 102 to communicate with responder VME module 104 via parallel multi-drop bus network 106 using any of VMEbus based protocols cited above. In effect, bridge unit 110 bridges data commands, requests, and the like, between the PCI based protocols and the VMEbus protocols.

As shown in FIG. 1, multi-service platform system 100 can include responder VME module 104, which can include subunit 130 and bridge unit 141 similar to initiator VME module 102. For example, subunit 130 can include processor 132, memory 134 and system controller 136. Subunit 130 can be coupled to bridge unit 141 and communicate using PCI or PCI-X protocols as discussed above. Bridge unit 141 can communicate with parallel multi-drop bus network 106 using any of the VMEbus protocols discussed above. Responder VME module 104 can include any number of subunits and be within the scope of the invention.

In an embodiment, initiator VME module 102 can initiate a read request or write data request to responder VME module 104. Read and write requests can include any type of electronic data that is understandable by responder VME module 104. Both read and write requests involve the transfer of data and can include an address phase, calibration phase and data phase discussed in more detail below.

Any number of modules can be included in multi-service platform system 100. Also, the role of initiator VME module 102 and responder VME module 104 are not fixed. For example, these roles can be reversed depending on which module is initiating communication. Therefore, any module in multi-service platform system 100 can be an initiator VME module if it initiates communication with another module. Also, any module in multi-service platform system 100 can be a responder VME module if it receives a request for communication from another module.

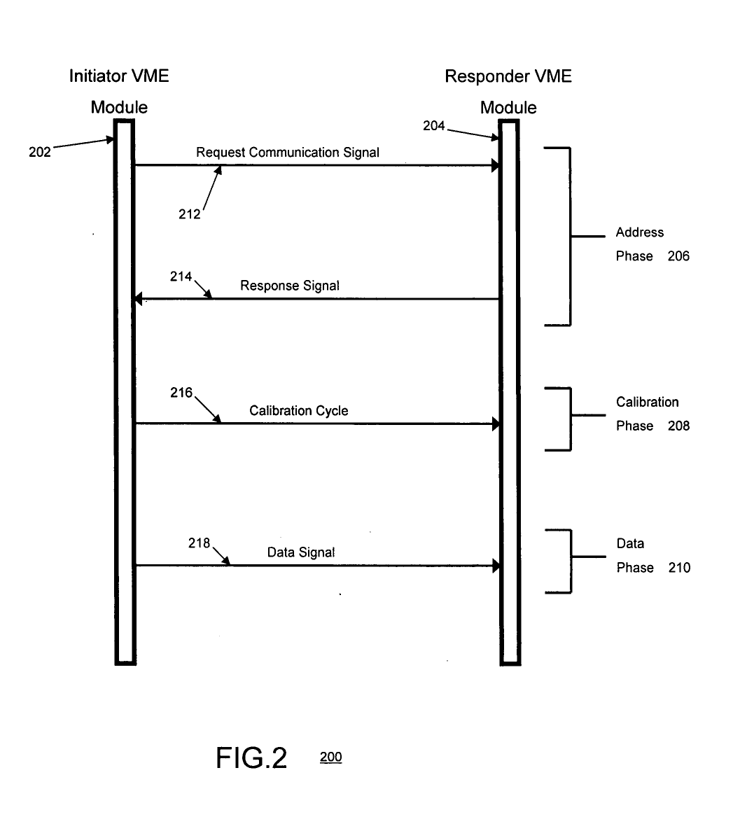

FIG. 2 depicts a ladder diagram 200 according to an embodiment of the invention. Data transfers between modules, whether read request or write requests, can have three phases, an address phase 206, a calibration phase 208 and a data phase 210. In the address phase 206, initiator VME module 202 initiates communication with the responder VME module 204 using a compelled (i.e. handshake) signaling process. The compelled (handshake) signaling process can be used with any VMEbus protocol regardless of whether the protocol is source synchronous. In an embodiment, calibration phase 208 and data phase 210 can take place, using source synchronous protocols.

The ladder diagram 200 depicted in FIG. 2 illustrates an embodiment where initiator VME module 202 writes data to responder VME module 204. In an analogous embodiment, where initiator VME module 202 requests data from responder VME module 204, the direction of the arrows in the calibration phase 208 and the data phase 210 are reversed. This is not limiting of the invention as the invention applies to either a read request or write function, as the role of initiator VME module 202 and responder VME module 204 can be reversed and still be within the scope of the invention.

In the address phase 206, the responder VME module's 204 address can be indicated along with the type of VME protocol to be used, for example and without limitation, 2eSST protocol. If a source synchronous protocol 107 is to be used, for example 2eSST, also indicated in the address phase 206 can be the transfer speed (clock speed of the transfer) to be used, for example, 160 megabytes per second (Mb/s), 267 Mb/s, 320 Mb/s, and the like. When using the 2eSST protocol, the initiator VME module (the module who initiates data transfer) sets the transfer speed. In an embodiment, the protocol to be used for data transfer is indicated using extended address modifier (XAM) code. XAM code in general is known in the art.

As shown in FIG. 2, the compelled signaling process can begin with initiator VME module 202 initiating communication with responder VME module 204 by sending request communication signal 212, which can include the address of responder VME module 204, protocol to be used, and the like. The address of responder VME module 204 can include, for example and without limitation, slot number or other identification means.

If responder VME module 204 recognizes request communication signal 212, responder VME module 204 can communicate response signal 214 back to initiator VME module 202 to indicate that data transfer may now proceed, whether it is a read request or write function.

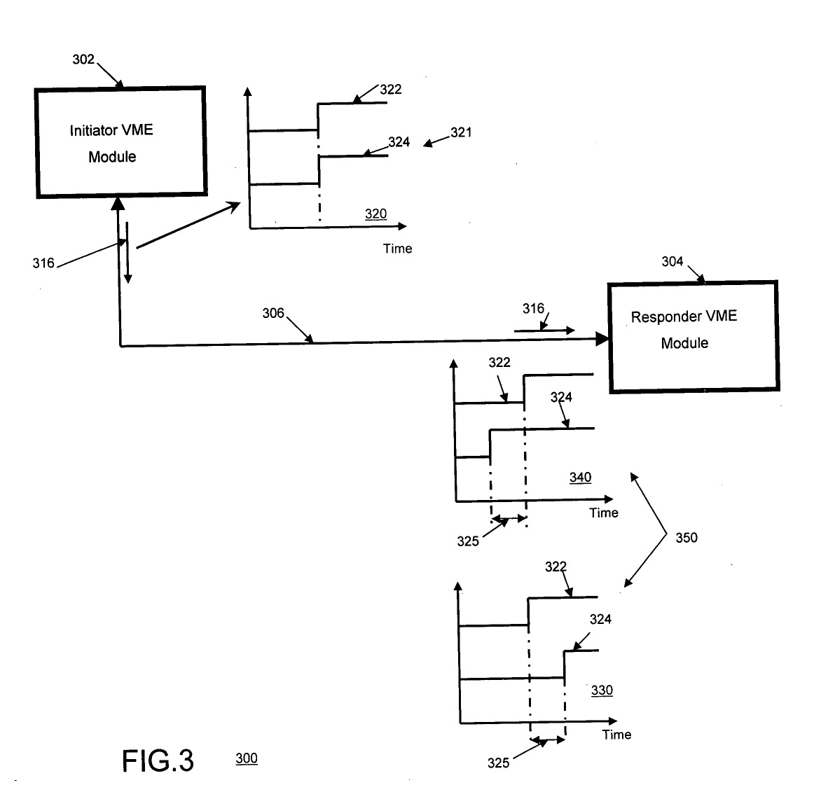

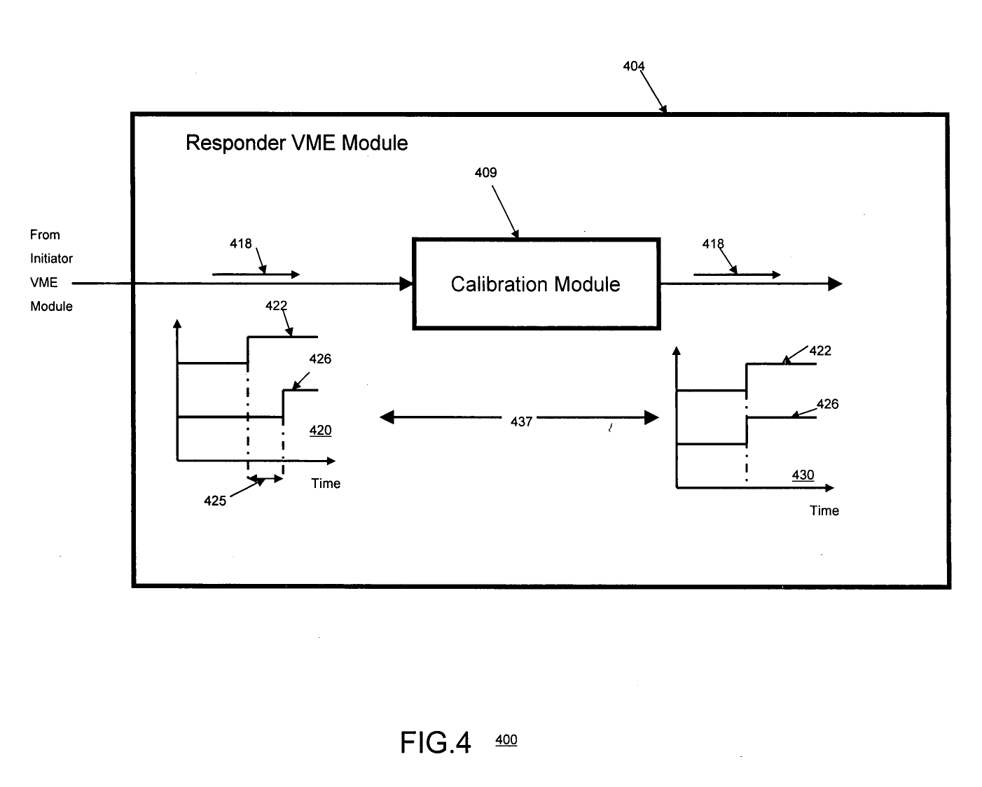

In an embodiment, following address phase 206 can be calibration phase 208. As noted above, the roles of initiator VME module 202 and responder VME module 204 as shown in FIG. 2 are for a write function. In a read request function, the direction of the calibration cycle 216 and data signal 218 are reversed. In calibration phase 208 initiator VME module 202 can communicate calibration cycle 216 to responder VME module 204. Calibration cycle 216 can include a reference signal and a training data signal (explained more fully in FIGS. 3 and 4 below) to allow responder VME module 204 to adjust subsequent data signal 218 in the data phase 210 to account for “skew” between reference signal and data signal 218. Calibration cycle is analogous to data signal in that both include a reference signal and a type of data signal. In the calibration cycle 216, a reference signal is included with a training data signal so that responder VME module 204 can calculate “skew.” In the data signal 218, the reference signal is included along with the actual data signal. With responder VME module 204 knowing the “skew” from the calibration cycle 216, data signal 218 can be adjusted to account for “skew” as explained more fully below.

In an embodiment, data phase 210 follows calibration phase 208. In data phase 210, data signal 218 is communicated from initiator VME module 202 to responder VME module 204. Data signal 218 can be a read request, write request, and the like, depending on its direction as discussed above. Data signal 218 can also include a reference signal and an actual data signal as discussed more fully below. In an embodiment, in the data phase, up to 2 kilobytes of data can be transferred using the protocol indicated in the address phase. An address phase, calibration phase and data phase together represent one transaction. A data phase in one transaction can include the transfer of up to, for example, 2048 bytes of data. In an embodiment, calibration phase is only completed once for each transaction. For a new transaction, calibration phase can be repeated. Each new transaction between a different initiator VME module and responder VME module pair can require a calibration phase as the skew can be different between each of these pairs.

FIG. 3 depicts a multi-service platform system 300 according to another embodiment of the invention. As shown in FIG. 3, multi-service platform system 300 includes initiator VME module 302 coupled to responder VME module 304 via parallel multi-drop bus network 306. In an embodiment, initiator VME module 302 communicates calibration cycle 316 to responder VME module 304. Calibration cycle 316 can be communicated after communication has been established between initiator VME module 302 and responder VME module 304 in address phase 206 as discussed above.

In an embodiment, calibration cycle 316 can include reference signal 322 and training data signal 324 as depicted in timing diagram 320. Reference signal 322 and training data signal 324 can have a preset relationship 321, such that the changes of amplitude or bits (going high and low) and of timing of the signals are known relative to each other. For example, reference signal 322 changing from a “low” condition to a “high” condition can occur at the same time as training data signal 324 changing from a “low” to a “high” condition. This example is not limiting of the invention. Any relationship between reference signal 322 and training data signal 324 can included in calibration cycle 316. Preset relationship 321 merely implies that the timing of the signals are known relative to each other and changes in amplitude or bits are known relative to each other.

In an embodiment, preset relationship 321 of calibration cycle 316 is known by both initiator VME module 302 and responder VME module 304. This is such that any deviation 350 in preset relationship 321 of reference signal 322 and training data signal 324 when they arrive at responder VME module 304 can be detected by responder VME module 304. For example and without limitation, calibration cycle 316 can be sent such that reference signal 322 and training data signal 324 go “high” at the same time as illustrated in timing diagram 320. Imperfections, other traffic, and the like, in initiator VME module 302, backplane hosting parallel multi-drop bus network 306, propagation time through VMEbus sending and receiving buffers and responder VME module 304, can cause calibration cycle 316 to be “skewed” when it reaches responder VME module 304. The “skew” that is being measured is between reference signal (dsl for write functions and dtack for read requests) and each training data signal. Although only one training data signal is shown, any number of training data signals can be included in calibration cycle 316 and be within the scope of the invention.

Examples of the “skewed” calibration cycle 316 are illustrated in timing diagram 330 and timing diagram 340. In both timing diagrams, which are exemplary and without limitation, there is a change in the order of receipt of reference signal 322 and training data signal 324, which introduces delay time 325 between reference signal 322 and training data signal 324. In one embodiment illustrated in timing diagram 330, reference signal 322 is received before training data signal 324, which introduces delay time 325 between the two signals. In another embodiment illustrated in timing diagram 340, training data signal 324 is received before reference signal 322, which introduces delay time 325. In either exemplary embodiment, the order of receipt of both signals is different from the order in which they were sent (simultaneously in this example). The change in order of receipt introduces delay time 325. Both the change in order of receipt and delay time 325 are examples of “skew” of calibration cycle detected by responder VME module 304.

Although only one training data signal 324 is shown in FIG. 3, any number of training data signals can be included in calibration cycle 316. For example and without limitation, calibration cycle 316 can include 64 training data signals. Each training data signal can have its own order of receipt relative to reference signal 322, and therefore its own delay time relative to reference signal 322.

FIG. 4 depicts a multi-service platform system 400 according to yet another embodiment of the invention. As shown in FIG. 4, responder VME module 404 can receive data signal 418 subsequent to receiving calibration cycle 316. Data signal 418 can be communicated from initiator VME module (not shown for clarity) and communicated over parallel multi-drop bus network (also not shown for clarity).

The skew of calibration cycle 316 is known from measurements performed during calibration phase 208 using calibration cycle 216, 316. When a signal is transmitted from initiator VME module (not shown for clarity) to responder VME module 404, calibration module 409 can be included in responder VME module 404 to correct data signal 418 for “skew.” Calibration module 409 can be any combination of hardware, firmware or software that operates to detect and correct for skew in data signal 418 based on calibration cycle 316 analyzed previously. In other words, calibration module 409 performs skew adjustment 437 in responder VME module 404.

Data signal 418 can include reference signal 422, which can act as a timing signal. Data signal 418 can also include at least one actual data signal 426, where actual data signal 426 can include real data transmitted from an initiator VME module. Each actual data signal 426 can correspond to a training data signal 324 in calibration cycle 316. In an embodiment, there can be an equal or greater number of training data signals 324 in calibration cycle 316 as actual data signals 426 in data signal 418.

As shown in FIG. 3 with reference to calibration cycle 316, a signal sent from initiator VME module to responder VME module 304 can include “skew” in the signals. The amount of “skew” in calibration cycle 316 can be the same as the skew found in data signal 418 communicated between the same pair of initiator VME module and responder VME module. Since the amount and type of “skew” is known, calibration module 409 can correct “skew” in incoming data signal 418.

For example and without limitation, data signal 418 can include “skew” as shown in timing diagram 420, where reference signal 422 is received before actual data signal 426, thereby including delay time 425. When data signal 418 is processed through calibration module 409, which has been calibrated via calibration cycle 316 as described above, data signal 418 can be adjusted such that “skew” is removed. This is shown in timing diagram 430 where reference signal 422 and actual data signal 426 are returned to being received at the same time, thereby eliminating the delay time 425. This can be done by buffering either reference signal 422 or actual data signal 426 until the other one arrives.

The embodiment, shown in FIG. 4 is not limiting of the invention. Other patterns of reference signal 422 and actual data signal 426 are within the scope of the invention. For example, actual data signal 426 can be received before reference signal 422, with calibration module 409 adjusting for the “skew” in an analogous manner. Also, calibration cycle 316 and data signal 418 can have any order of receipt or delay time built in and be within the scope of the invention. For example, reference signal 422 and actual data signal 426 do not have to be in sync, as it may be normal for these two signals to be out of sync. In this instance the method of the invention functions to correct for “skew” in a manger analogous to that described above.

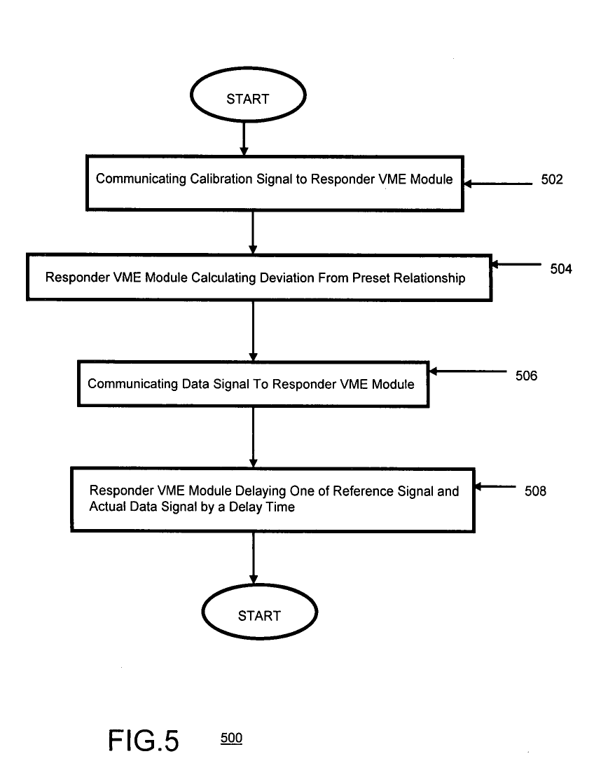

FIG. 5 illustrates a flow diagram 500 of a method of the invention according to an embodiment of the invention. The method of the invention includes providing an initiator VME module coupled to a responder VME module over a parallel multi-drop bus network. In step 502 the initiator VME module communicates a calibration cycle to the responder VME module during a calibration phase, where the calibration cycle includes a reference signal and a training data signal having a preset relationship, and where the calibration cycle is communicated using a source synchronous protocol.

In step 504 the responder VME module calculates a deviation from the preset relationship of the reference signal and the training data signal, where the deviation comprises a delay time.

In step 506 the initiator VME module communicates a data signal to the responder VME module during a data phase, where the data signal includes the reference signal and an actual data signal. In step 508 the responder VME module delays one of the reference signal and the actual data signal by the delay time. Step 508 can be the beginning of the write data function or read data function as discussed above.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. In a multi-service platform system, a method of skew adjustment, comprising:
providing an initiator VME module coupled to a responder VME module over a parallel multi-drop bus network;
the initiator VME module communicating a calibration cycle to the responder VME module during a calibration phase, wherein the calibration cycle includes a reference signal and a training data signal having a preset relationship, and wherein the calibration cycle is communicated using a source synchronous protocol;
the responder VME module calculating a deviation from the preset relationship of the reference signal and the training data signal, wherein the deviation comprises a delay time;
the initiator VME module communicating a data signal to the responder VME module during a data phase, wherein the data signal includes the reference signal and an actual data signal; and
the responder VME module delaying one of the reference signal and the actual data signal by the delay time.

2. The method of claim 1, wherein calculating the deviation from the preset relationship comprises:
the responder VME module measuring the delay time between the reference signal and the training data signal; and
the responder VME module determining an order of receipt of the reference signal and the training data signal.

3. The method of claim 1, wherein calculating the deviation from the preset relationship comprises determining which one of the reference signal and the training data signal are received first.

4. The method of claim 3, wherein the responder VME module delaying comprises:
if the reference signal in the calibration cycle is received first, the responder VME module delaying the reference signal in the data signal by the delay time; and
if the training data signal in the calibration cycle is received first, the responder ME module delaying the actual data signal in the data signal by the delay time.

5. The method of claim 1, wherein the source synchronous protocol is a two edge source synchronous protocol.

6. In a responder VME module, a method of skew adjustment, comprising:
the responder VME module coupled to an initiator VME module over a parallel multi-drop bus network;
the responder VME module receiving a calibration cycle from the initiator VME module during a calibration phase, wherein the calibration cycle includes a reference signal and a training data signal having a preset relationship, and wherein the calibration cycle is communicated using a source synchronous protocol;
the responder VME module calculating a deviation from the preset relationship of the reference signal and the training data signal, wherein the deviation comprises a delay time;
the responder VME module receiving a data signal from the initiator VME module during a data phase, wherein the data signal includes the reference signal and an actual data signal; and
the responder VME module delaying one of the reference signal and the actual data signal by the delay time.

7. The method of claim 6, wherein calculating the deviation from the preset relationship comprises:
the responder VME module measuring the delay time between the reference signal and the training data signal; and
the responder VME module determining an order of receipt of the reference signal and the training data signal.

8. The method of claim 6, wherein calculating the deviation from the preset relationship comprises determining which one of the reference signal and the training data signal are received first.

9. The method of claim 8, wherein the responder VME module delaying comprises:
if the reference signal in the calibration cycle is received first, the responder VME module delaying the reference signal in the data signal by the delay time; and
if the training data signal in the calibration cycle is received first, the responder VME module delaying the actual data signal in the data signal by the delay time.

10. The method of claim 6, wherein the source synchronous protocol is a two edge source synchronous protocol.

11. In a multi-service platform system having an initiator VME module coupled to a responder VME module over a parallel multi-drop bus network, a method of skew adjustment, comprising:
using a source synchronous protocol, the initiator VME module communicating a calibration cycle to the responder VME module during a calibration phase;
the responder VME module calculating a deviation from a preset relationship in the calibration cycle;
the initiator VME module communicating a data signal to the responder VME module during a data phase, wherein the data signal includes a reference signal and an actual data signal; and
the responder VME module delaying one of the reference signal and the actual data signal by the deviation from the preset relationship.

12. The method of claim 11, wherein calculating the deviation from the preset relationship comprises:
the responder VME module measuring a delay time between a reference signal and a training data signal in the calibration cycle; and
the responder VME module determining an order of receipt of the reference signal and the data signal.

13. The method of claim 12, wherein calculating the deviation from the preset relationship comprises determining which one of the reference signal and the training data signal are received first.

14. The method of claim 13, wherein the data signal comprising the reference signal and an actual data signal, wherein the responder VME module delaying comprises:
if the reference signal in the calibration cycle is received first, the responder VME module delaying the reference signal in the data signal by the delay time; and
if the training data signal in the calibration cycle is received first, the responder VME module delaying the actual data signal in the data signal by the delay time.

15. The method of claim 11, wherein the source synchronous protocol is a two edge source synchronous protocol.

16. In a responder VME module, coupled to an initiator VME module over a parallel multi-drop bus network, a method of skew adjustment, comprising:
using a source synchronous protocol, the responder VME module receiving a calibration cycle from the initiator VME module during a calibration phase;
the responder VME module calculating a deviation from a preset relationship in the calibration cycle;
the responder VME module receiving a data signal from the initiator VME module during a data phase, wherein the data signal includes a reference signal and an actual data signal;
the responder VME module delaying one of the reference signal and the actual data signal by the deviation from the preset relationship; and
repeating the calibration phase for each data phase.

17. The method of claim 16, wherein calculating the deviation from the preset relationship comprises:
the responder VME module measuring a delay time between a reference signal and a training data signal in the calibration cycle; and
the responder VME module determining an order of receipt of the reference signal and the data signal.

18. The method of claim 17, wherein calculating the deviation from the preset relationship comprises determining which one of the reference signal and the training data signal are received first.

19. The method of claim 18, wherein the data signal comprising the reference signal and an actual data signal, wherein the responder VME module delaying comprises:
if the reference signal in the calibration cycle is received first, the responder VME module delaying the reference signal in the data signal by the delay time; and
if the training data signal in the calibration cycle is received first, the responder VME module delaying the actual data signal in the data signal by the delay time.

20. The method of claim 16, wherein the source synchronous protocol is a two edge source synchronous protocol.
